(19) United States
(12) Patent Application Publication
(10) Pub. No.: US 2010/0188412 A1
(43) Pub. Date: Jul. 29, 2010

(54) CONTENT BASED CACHE FOR GRAPHICS RESOURCE MANAGEMENT

(75) Inventors: Chen Li, Redmond, WA (US); Jinyu Li, Redmond, WA (US); Xin Tong, Beijing (CN); Barry C. Bond, Maple Valley, WA (US); Gang Chen, Beijing (CN)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/361,216

(22) Filed: Jan. 28, 2009

(51) Int. Cl. G09G 5/36

(52) U.S. Cl. 345/557

(57) ABSTRACT

Providing content based cache for graphic resource management is disclosed herein. In some aspects, a portion of a shadow copy of graphics resources is updated from an original copy of the graphics resources when a requested resource is not current. The shadow copy may be dedicated to a graphics processing unit (GPU) while the original copy may be maintained by a central processing unit (CPU). In further aspects, the requested graphics resource in the shadow copy may be compared to a corresponding graphics resource in the original copy when the GPU requests the graphics resource. The comparison may be performed by comparing hashes of each graphics resource and/or by comparing at least a portion of the graphics resources.

### BACKGROUND

Graphics processing enables video or other graphics rendered for output to a display. Because the human eye can detect very subtle inconsistencies and errors in an output of graphics, graphics must be processed rapidly. Some computing systems are optimized to process graphics. These systems may include a dedicated graphic processing unit (GPU) for rendering graphics along with a central processing unit (CPU) that handles general task processing.

When using a GPU to process graphics, it is important to transmit the appropriate data from the CPU to the GPU for graphics processing. When the CPU transmits too much information to the GPU, the CPU may become bogged down by unnecessary tasks, which may adversely affect the rate of processing other tasks. Also when the CPU transmits too much information to the GPU, the GPU may not have current data for rendering an appropriate graphics output and therefore may not provide a correct graphics output.

The gaming industry is heavily reliant on rapid graphic processing. The GPU in a gaming console typically processes graphic resources that include textures, vertex buffers, and index buffers that are used in 3D rendering applications. For example, a first-person adventure game may include many resources that must be maintained in memory that is accessible to the GPU, and must be updated many times per second to properly render a 3D environment. It is important that the graphics resources are properly updated to enable the GPU to accurately process and display 3D environments as intended.

### SUMMARY

Providing content based cache for graphics resource management is disclosed herein. In some aspects, a portion of a shadow copy of graphics resources is updated from an original copy of the graphics resources when a requested resource is not current. The shadow copy may be dedicated to a graphics processing unit (GPU) while the original copy may be maintained by a central processing unit (CPU).

In further aspects, a hash table may include hashes for each of the graphics resources that are loaded in the shadow copy. When a graphics resource is requested by the GPU from the shadow copy, a hash key may be generated for a corresponding graphics resource in the original copy. The hash key may be used to search the hash table for a matching hash. If the hash key does not match a hash in the hash table, the shadow copy may be updated with the graphics resource from the original copy to update the requested resource. The GPU may then render the updated graphics resource.

This summary is provided to introduce simplified concepts of content based cache for graphics resource management, which is further described below in the Detailed Description. This summary is not intended to identify essential features of the claimed subject matter, nor is it intended for use in determining the scope of the claimed subject matter.

### BRIEF DESCRIPTION OF THE DRAWINGS

The Detailed Description is described with reference to the accompanying figures. In the figures, the left-most digit(s) of a reference number identifies the figure in which the reference number first appears. The same reference number in different figures refers to similar or identical items.

FIG. 1 is a schematic of an illustrative environment of a first processor and a second processor that has content based cache for graphics resource management, in accordance with at least one embodiment.

FIG. 2 shows an illustrative graphics resource allocation at various processing times for a first and second processor and graphic resource management of the graphics resources using a hash key, in accordance with at least one embodiment of content based cache for graphics resource management.

FIG. 3 is a flow diagram of an illustrative process of using a content based cache with hash keys for graphic resource management, in accordance with at least one embodiment

FIG. 4 is a flow diagram of an illustrative process of using a content based cache with hash keys and a resource comparison for graphic resource management, in accordance with at least one.

FIG. 5 shows a pictorial flow diagram of an illustrative process of a resource comparison of textures with a mipmap chain, in accordance with at least one embodiment.

FIG. 6 shows a pictorial flow diagram of an illustrative process of a resource comparison of textures without mipmap, in accordance with at least one embodiment.

FIG. 7 shows a pictorial flow diagram of an illustrative process of a resource comparison of a vertex buffer, in accordance with at least one embodiment.

FIG. 8 shows a pictorial flow diagram of an illustrative process of a resource comparison of an index buffer, in accordance with at least one embodiment.

FIG. 9 shows an illustrative computing system that may be used to implement the content based cache for graphic resource management as shown in the environment of FIG. 1.

### DETAILED DESCRIPTION

### Overview

As discussed above, graphics resources may be textures, vertex buffers, and index buffers that are used in 3D rendering applications. Textures are images, which may be stored at one or more resolution. Vertex buffers and index buffers are arrays of data. A typical real time 3D rendering application, like a computer game, may need thousands of different graphics resources for rendering one final image. The content of the resources might be updated by a CPU during runtime, which are then processed by the GPU to render the final image.

Generally, a shadow copy of graphics content is maintained for access by the GPU so that the CPU's write operations and the GPU's write operations can be performed separately. When an original graphics resource (original copy) is modified by the CPU, a synchronization operation may be invoked to update the shadow copy. The synchronization operation may involve a lot of additional computation or even format conversion. Thus it may be very resource intensive and require a substantial amount of CPU activity. Accordingly, it is desirable to minimize the number of synchronization operations for a graphics resource management system to free up the CPU for other tasks, expedite updating the shadow copy, and for other advantageous reasons.

A content-based cache scheme to manage the shadow copy of graphics resources is disclosed herein. In some embodiments, a content scan of the resource is performed when the resource is used by GPU. If the original copy of the resource is updated on the original copy, the resource may be updated on the shadow copy without updating the entire shadow copy. Methods, computing instructions, and systems for maintaining a shadow copy of graphics resources that allow efficient synchronization between the CPU's original copy and the GPU's shadow copy are disclosed herein.

### Illustrative Environment

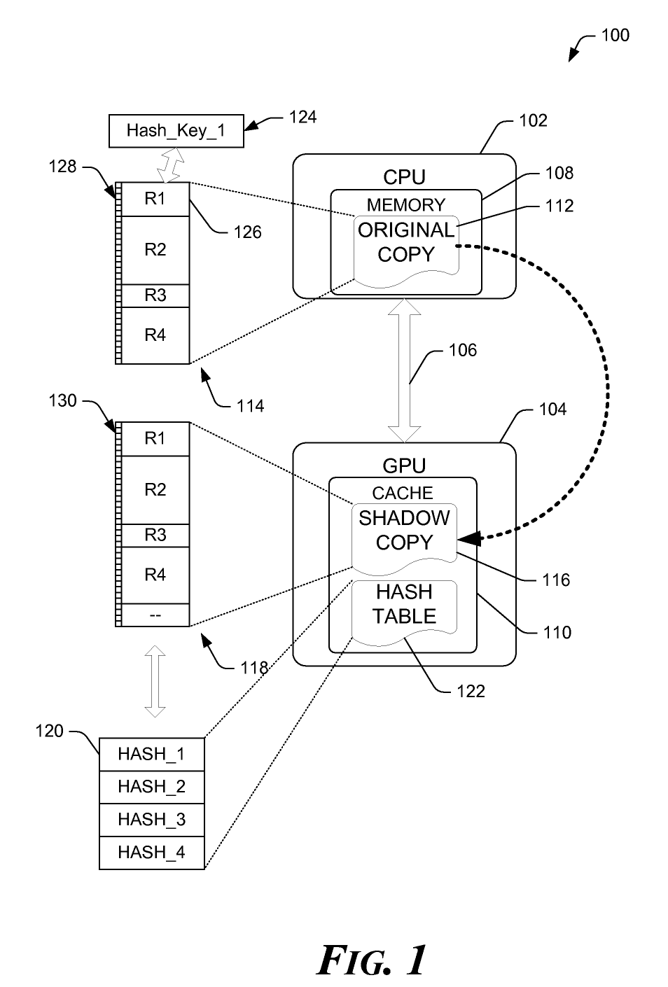

FIG. 1 is a schematic of an illustrative environment 100 of a first processor 102 and a second processor 104 that has content based cache for graphics resource management. In some embodiments, the first processor 102 may be a central processing unit (CPU) while the second processor 104 may be a graphics processing unit (GPU). For simplicity, the first processor 102 and the second processor 104 will be referred to as “the CPU 102” and “the GPU 104,” although other configurations, including more processors may be included in embodiments that are within the scope of the disclosure.

The CPU 102 and the GPU 104 may be communicatively coupled via a bus 106 to enable data transfer between the CPU 102 to the GPU 104. The CPU 102 may include memory 108, which may be implemented as level 1 or level 2 caches, among other possible configurations. The GPU 104 may include cache 110 for storing data that requires relatively quick access by the GPU 104.

In accordance with various embodiments, the CPU 102 may include an original copy 112 of graphics resources 114, which may be stored in the memory 108. The graphics resources 114 may include textures, vertex buffers, and index buffers that are used in rendering applications, such as 3D applications.

The GPU 104 may include a shadow copy 116 of loaded graphics resources 118, which may be stored in the cache 110. The shadow copy 116 may be populated periodically by writing one or more of the graphics resources 114 to the cache 110 to update the loaded graphics resources. In some embodiments, the shadow copy 116 may include more resources than are present in the original copy 112, such as when the cache 110 is larger than the amount of the memory 108 that is allocated to store the original copy. Conversely, the shadow copy 116 may include fewer resources than are present in the original copy 112. The cache 110 may have resources removed from the cache that are no longer used to free space for new resources, which may be provided to the shadow copy 116 from the original copy 112, via the CPU 102.

In operation, the CPU 102 may load the original copy 112 having the graphics resources 114. The CPU 102 may write one or more of the graphics resources 114 to the cache 110 of the GPU 104 to populate the shadow copy 116. At a second time, a resource may be updated in the original copy 112, which may require another write operation to update the shadow copy 116 accordingly.

In accordance with some embodiments, a hash value (or simply “hash”) 120 may be generated for each of the loaded graphics resources 118 to populate a hash table 122. The hash 120 may be generated using various known hash generation techniques that enable generation of a relatively unique hash (i.e., number) from data of a graphics resource. In some embodiments, the hash 120 may be a 64-bit integer; however, other size hashes may be used. The hash table 122 may include a dynamic list of all the resources in the shadow copy 116, each in the form of the hash 120. Each hash in the hash table 122 is a graphics resource that is about to be used or was used recently in rendering by the GPU 104.

A hash key 124 may be generated from the graphics resources 114 of the original copy 112. In some embodiments, the hash key 124 may be compared to the hash table 122 to determine if a graphics resource 114 in the original copy 112 is loaded in the shadow copy 116. For example, the graphics resource, such as a first resource (R1) 126 may have a corresponding one of the hash key 124 that is generated for the first resource. In addition, a matching hash (e.g., the hash 120) may exist in the hash table 122 that matches the first resource 126. This may indicate that the graphics resource R1 126 is present in both the original copy 112 and the shadow copy 116, and thus the shadow copy does not require an update. However, further investigation may be warranted depending on various factors, such as the strength (i.e., uniqueness) of the hash, which is discussed in further detail below.

In various embodiments, the content of the loaded graphics resources 118 is scanned when a resource is requested by the GPU 104. For example, when the GPU 104 attempts to process the resource, a synchronization check may be performed. When a new resource request occurs, a new hash key 124 may be generated based on current content of the graphics resource from the original copy 112. The hash key 124 may then be used in a search of a hash table 122.

Although the graphics resources 114 are associated with a memory page 128 and the loaded graphics resources 118 are associated with a cache page 130, the page 128 may or may not include page protection. Regardless of whether page protection is employed, the entire shadow copy of loaded graphics resources is not updated upon a page protection violation, but instead, individual graphics resources are updated after being requested by the GPU 104 using content based cache as disclosed herein.

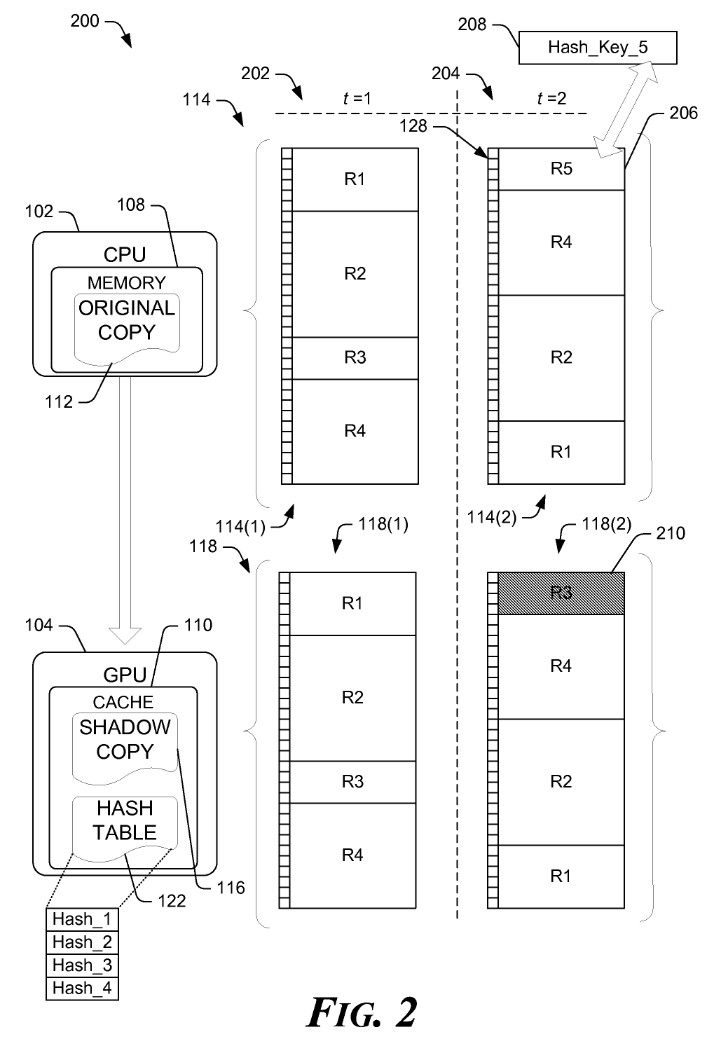

FIG. 2 shows an illustrative graphics resource allocation 200 at various processing times for the CPU 102 and the GPU 104. The graphics resources 114 stored in the memory 108 and the loaded graphics resources 118 stored in the cache 110 are shown for a first arbitrary time (t1) 202 and a subsequent time (t2) 204 to illustrate detection of a modified resource. It should be noted that there may be no differentiation between a new resource and a modified resource because with content based cache, a modified resource is not distinguished from a new resource.

With regard to the CPU 102, FIG. 2 shows a selection of memory that, at a first arbitrary time (t1) 202, has four example graphics resources 114(1) including R1, R2, R3 and R4. At a subsequent time (t2) 204, R3 is unloaded from another four graphics resources 114(2) and R1, R2 and R4 are unloaded and loaded again to different memory locations, but are the same as the previously loaded R1, R2, and R4 in other respects such as content, size, etc. A new resource R5 206 is included at t2, which has been loaded to the memory 108. Thus, the graphics resources 114(2) include R1, R2, R4, and R5.

From point of view of traditional memory system, all of the pages 128 are touched and modified because the graphics resources 114(2) are stored in different locations in the memory 108 as compared to the graphics resources 114(1). With content based cache, only graphic resources that have changed between the first time 202 and the subsequent time 204 are updated, which results in substantial processing reduction of the CPU 102.

Now turning to the GPU 104, the loaded graphics resources 118(1) mirror the graphics resources 114(1) at the first time 202. At the subsequent time 204, a loaded graphics resource 118(2) includes R3 while the graphics resource 114(2) includes R5 206, but otherwise contains the same resources of R1, R2, and R4. When the GPU 104 requests a graphics resource, a message is transmitted to the CPU 102, which initiates generation of a hash key 208 based on the requested resources, such as R5 206. The hash key 208 is used to search the hash table 122, which may reside in the cache 110 of the GPU 104.

If the requested resource is not present in the hash table 122, the new resource may then be loaded to the cache 110 to update the shadow copy 116, as would happen in the situation illustrated in FIG. 2. For example, the shadow copy 116 may remove an old resource 210 to free memory for the new resource. However, if the hash key 208 was located in the hash table 122, additional processing may occur before the resource is deemed current and is used by the GPU 104.

As described with reference to the content based system, this synchronization process does not update the graphics resources R1, R2 and R4 because these resources are unchanged. To further illustrate, if the GPU 104 called R2 (or R1, or R4), the hash key 208 that is generated would be found in the hash table because the loaded graphics resources 118(2) contain R1, R2, and R4, and thus the shadow copy 116 may not be updated at this time, absent additional processing, which is discussed below.

In some embodiments, when the hash key 208 is located in the hash table 122, a more thorough content comparison may be to be performed to verify that the requested resource and the resource in cache (loaded in the shadow copy 116) are the same resource (e.g., same version, etc.). If the comparison determines the requested resource is the same as the resource in the cache, then there is no need to invoke a synchronization operation. If that key is not found or the more thorough content comparison determines the resource has changed, then an updated resource may be loaded from the original copy 112 to the shadow copy 116. Next, a hash and the resource may be inserted into hash table to update the hash table 122.

In situations where the hash table reaches a size limit of available memory, a resource may be released, such as the oldest resource, to make room for the new resource. A least recently used (LRU) algorithm or any other resource management algorithm can be used to make room for the new resource.

### Illustrative Operation

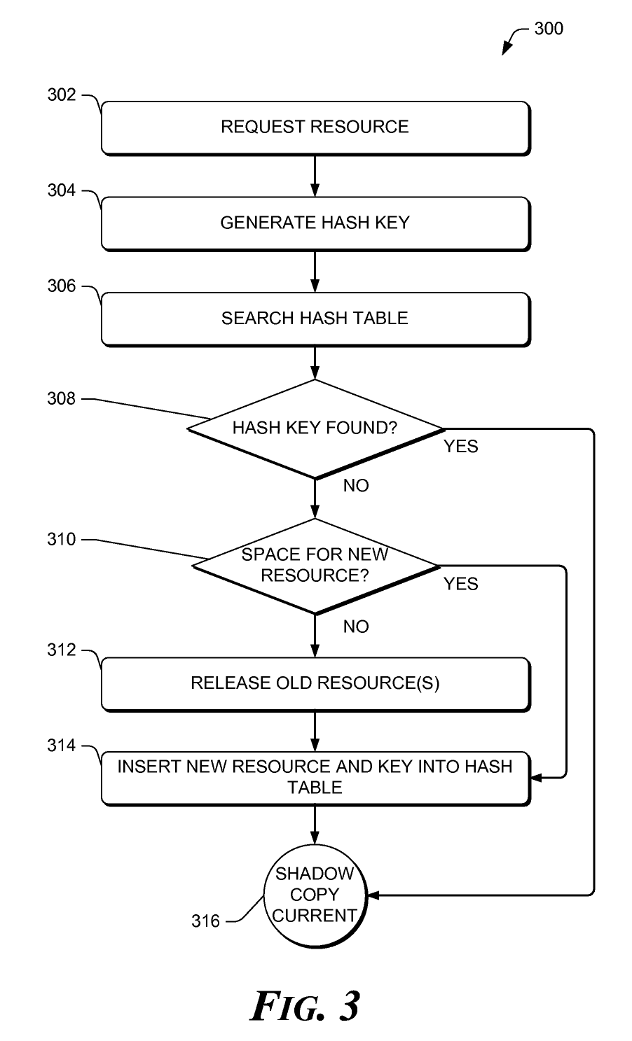

FIG. 3 is a flow diagram of an illustrative process 300 of using a content based cache with hash keys for graphic resource management. The process 300 is illustrated as a collection of blocks in a logical flow graph, which represent a sequence of operations that can be implemented in hardware, software, or a combination thereof. In the context of software, the blocks represent computer-executable instructions that, when executed by one or more processors, cause the one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Other processes described throughout this disclosure, in addition to process 300, shall be interpreted accordingly. Some of the operations of FIG. 3 are discussed with reference to the CPU 102 and GPU 104 of FIG. 1.

At 302, a resource is requested by the GPU 104. For example, the GPU 104 may need to render a resource, such as a texture, vector buffer, or index buffer.

At 304, the hash key 208 is generated by the CPU 102 for the requested resource at 302. In some embodiments, the hash key 208 may have a very strong correlation to the resource such that a hash key comparison to a corresponding has a very high likelihood of accurately predicting the occurrence or non-occurrence of a match of graphics resources. The hash key 208 with a strong correlation may be more time consuming to generate than hash keys having a lesser correlation with the graphics resource. In other embodiments, the hash key 208 may be generated using an optimized process that rapidly generates the hash key 208, but may sacrifice some accuracy to achieve faster hash key generation.

At 306, the hash key 208 is used to search the hash table 122. The CPU 102 may access the hash table 122, which may be stored in the cache 110. In other embodiments, the hash table 122 may be stored in other memory locations, such as, without limitation, the memory 108, system memory, RAM/ROM (random access memory/read only memory), and so forth.

At 308, a determination of whether the hash key 208 is found in the hash table 122 may occur. For example, the CPU 102 may locate a corresponding hash in the hash table 122 that matches the hash key 208 (positive identification, thus follow “yes” route to 316). Alternatively, the corresponding hash may not be found in the hash table 122 (failed identification, thus follow “no” route).

At 310, when the hash key 208 is not matched in the hash table 122 (follow “no” route from 308 to 310), a second determination may be conducted at 310 to determine whether there is available memory to upload a new resource (e.g., new resource R5 206 of FIG. 2) in the cache 110. Because the hash key 208 was not found in the hash table 122, the shadow copy 116 may be updated (synchronized) with the new resource. In some instances, memory may not available to store the new resource (follow “no” route from 310 to 312), while in other instances, memory may be available to store the new resource (follow “yes” route from 310 to 314).

At 312, an old resource may be released from the cache 110 to make room for the new resource. For example, an LRU algorithm may be used to select the resource to be released. In some instances, multiple resources may need to be released to make enough memory available to load the new resource.

At 314, the new resource is loaded in the cache 110 to synchronize the shadow copy 116 with the original copy 112. In addition, a new hash and may be inserted into the hash table 122 to update the hash table to accurately reflect the loaded graphics resources 118 in the shadow copy 116.

At 316, the shadow copy is current with the graphic resources. The shadow copy 116 may be current because of an upload of the new resource at 314, or because the shadow copy 116 already contained the requested resource of 302, which was determined at the operation 308.

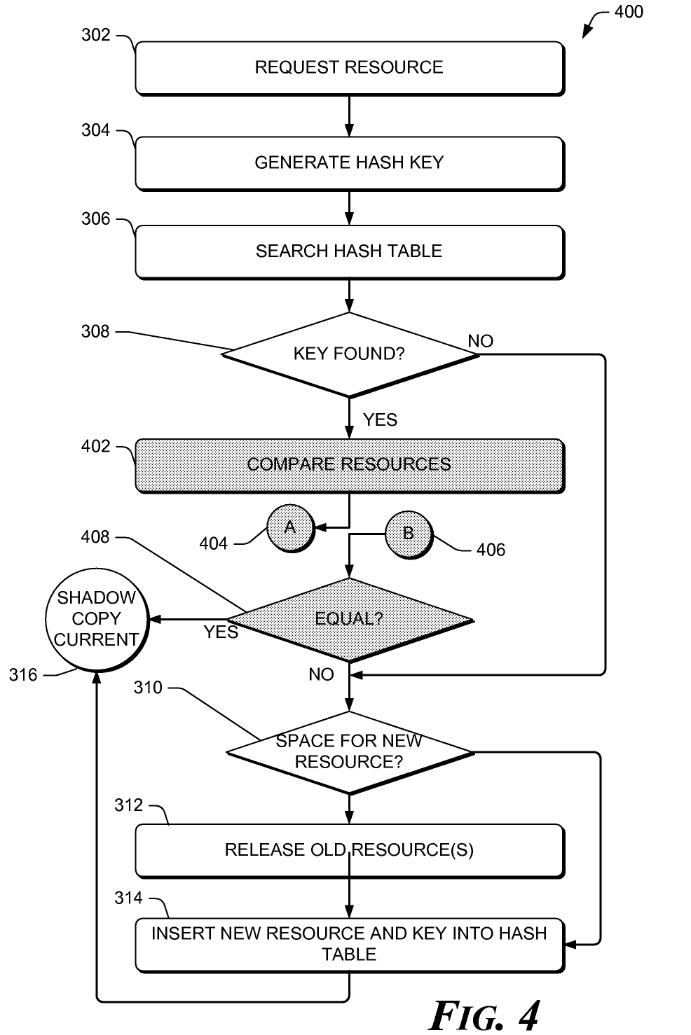

FIG. 4 is a flow diagram of an illustrative process 400 of using a content based cache with hash keys and a resource comparison for graphic resource management. Many of the operations included in the process 400 have been introduced in FIG. 3 and may include the similar or identical operations as discussed with regard to the process 300. Additionally, the arrangement of the blocks of the process 400 is not intended as a limitation, and other arrangements are contemplated.

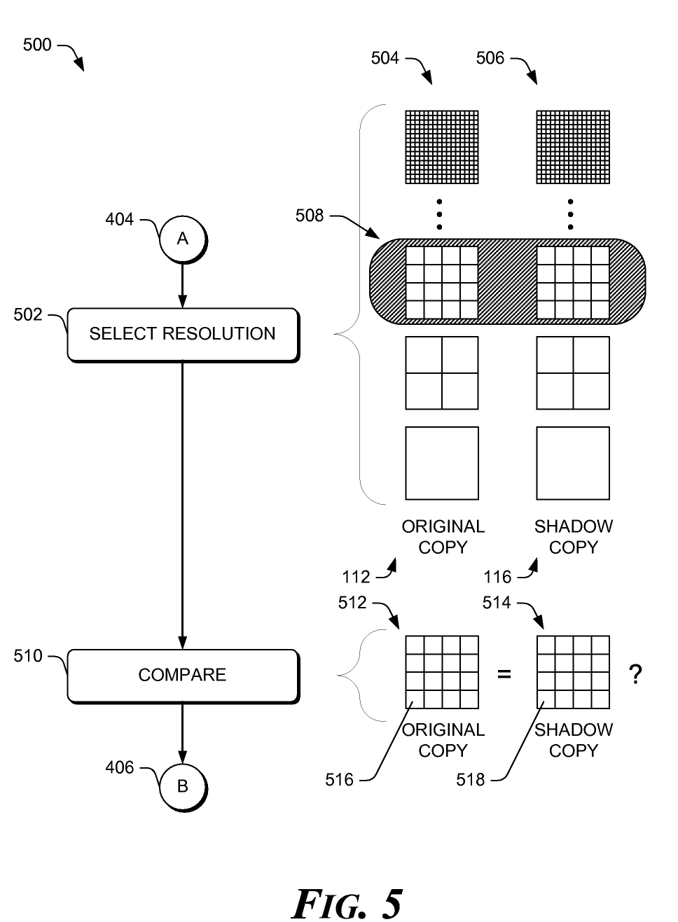

At 402, when the hash key 208 is found in the hash table 122, the graphics resources of in the original copy 112 and the shadow copy 116 are compared to determine whether they are the same. Between 404 and 406, specific comparisons may occur, which are described in detail below with respect to FIGS. 5-8.

At 408, a determination of whether the graphics resources, which are compared at 402, is conducted by the CPU 102. If the graphics resources are determined to be the same, then the process 400 follows the “yes” route to 316 because the shadow copy 116 is up-to-date. However, if the determination at 408 finds the graphics resources are not equal, then the process 400 follows the “no” route to the operation 310 and processing continues accordingly.

With regard to the process 300 and the process 400, accuracy of correctly identifying whether a requested resource is up-to-date may be sacrificed to increase processing speed of the synchronization (e.g., reduce CPU load, etc.). For example, it may be acceptable to fail to synch a resource that has some relatively minor features in a texture that are different than the resource in the original copy because these tiny features are usually unnoticeable. In accordance with some embodiments, a partial sample of the graphics resource for hash key calculation and for content comparison is usually acceptable. In FIGS. 5-8, various sample policies are shown and described for different type of graphics resources that take advantage of inherit data layout of graphics resources and achieve accuracy and performance that is generally acceptable for display to human viewers.

FIG. 5 shows a pictorial flow diagram of an illustrative process 500 of a resource comparison of textures with a mipmap (or MIP map) chain. The process 500 occurs when the graphic resources to be compared are textures with a mipmap chain. Mipmaps are collections of images (e.g., bitmap, etc.) that store the texture image in various resolutions. The original copy 112 may include a graphics resource with mipmapping 504 for comparison to a graphics resource with mipmapping 506 of the shadow copy 116.

At 502, a resolution may be selected for comparison from the various resolutions of the mipmap. For example, a resolution 508 may be selected that has an acceptable number of pixels (e.g., above a threshold number, etc.) to predict whether the shadow copy of the graphics resource is the same as the graphics resource stored in the original copy.

At 510, a comparison of the selected resolution graphics resources, 512, 514 may be conducted to determine whether they are the same. The accuracy of the comparison may vary depending on the selected resolution at 508. For example, a higher resolution selection may provide a more accurate result following a comparison because the sample size is greater (i.e., more pixels to compare). Of course, the comparing more pixels takes more processing, and thus a longer process (e.g., more CPU load, etc.). In some embodiments, the comparison may include comparing each pixel 516, 518 of the graphics resources 512, 514, respectively, to determine if they are the same.

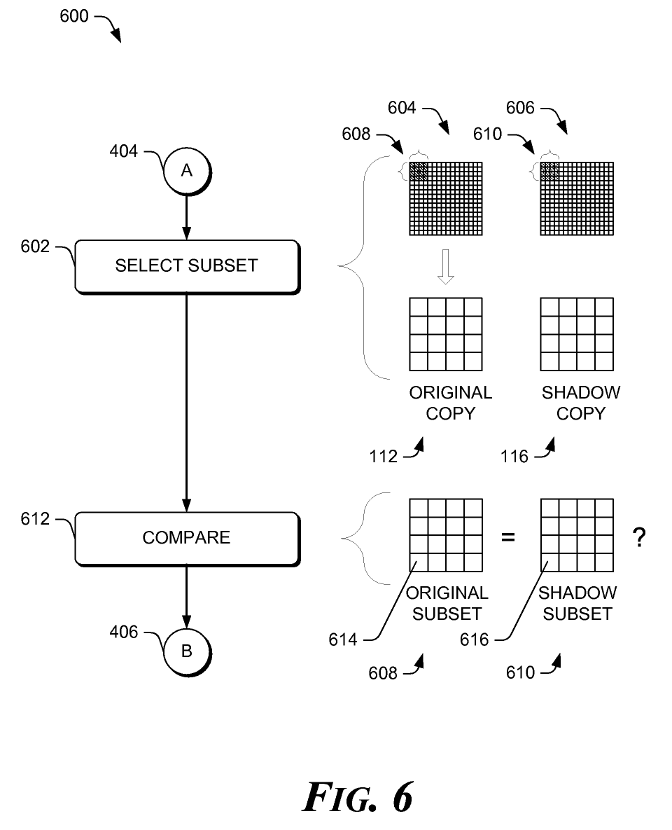

FIG. 6 shows a pictorial flow diagram of an illustrative process 600 of a resource comparison of textures without mipmap. The process 600 occurs when the graphic resources to be compared are textures without a mipmap chain. The original copy 112 may include a graphics resource image 604 for comparison to a graphics resource image 606 of the shadow copy 116.

At 602, subsets 608, 610 of the graphics resources 604, 606, respectively, may be selected for comparison. The subsets may be any portion of the entire image with good distribution and randomness. Each subset includes the same region of the graphics resource to create a valid comparison. A larger portion may provide a more accurate resultant of the comparison, but may take longer to process.

At 612, the subsets 608, 610 are compared to determine whether the shadow copy 116 should have the requested resource updated from the original copy 112. In some embodiments, the comparison may include comparing each texel (or texture pixel) 614, 616 of the subsets 608, 610, respectively, to determine if they are the same.

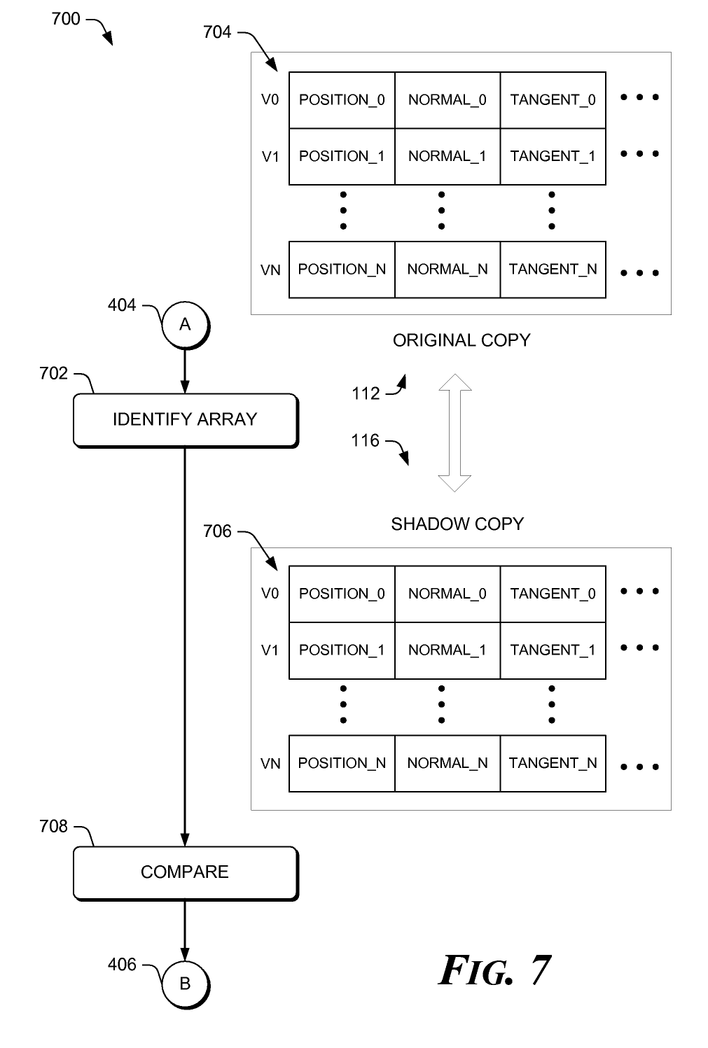

FIG. 7 shows a pictorial flow diagram of an illustrative process 700 of a resource comparison of a vertex buffer. The process 700 occurs when the graphic resources to be compared are vertex buffers. The original copy 112 may include a graphics resource vertex buffer 704 for comparison to a graphics resource vertex buffer 706 of the shadow copy 116.

At 702, the array of the vertex buffers 704, 706 is identified. For example, the entire array, or a portion thereof, is selected and identified prior to a comparison of the arrays. The vertex buffers can be treated as a 2D array, where one dimension includes different elements inside a vertex, and another dimension includes different vertices. A sampling algorithm may select a portion of the information from each dimension such that the selected portion has a good distribution and randomness. For example, selecting only even or odd data may generate an inaccurate comparison because some arrays may appear very similar when non-random samples are compared to one another.

At 708, the vertex buffers 704, 706 are compared to determine whether the shadow copy 116 should have the requested resource updated from the original copy 112. In some embodiments, the comparison may include comparing each element, or a portion of the elements in the arrays 704, 706 to determine if they are the same.

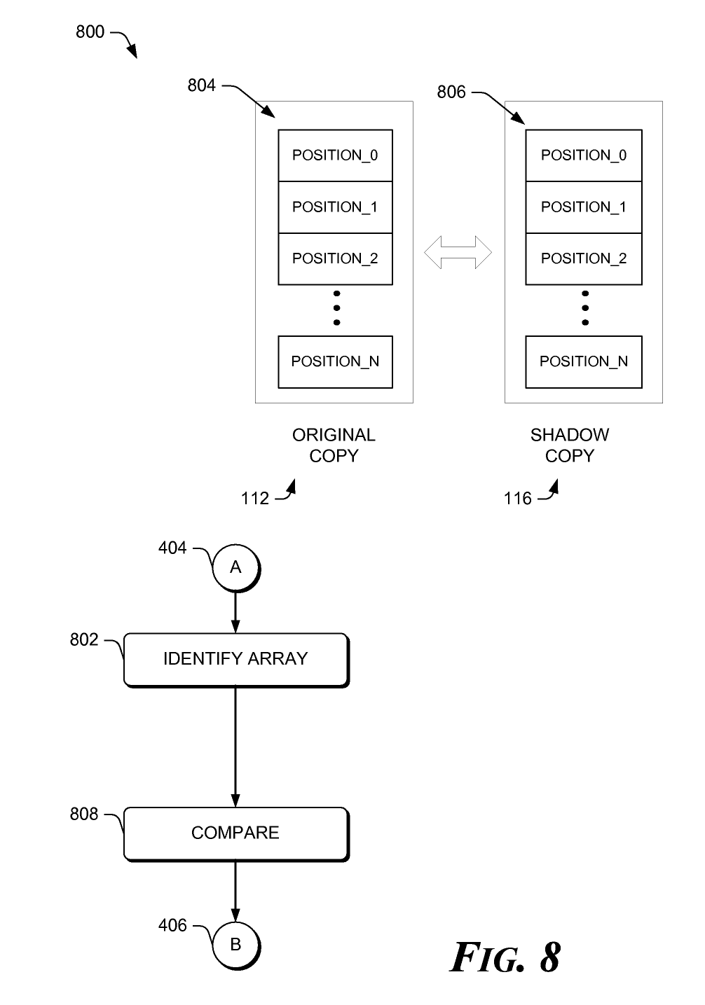

FIG. 8 shows a pictorial flow diagram of an illustrative process 800 of a resource comparison of an index buffer. The process 800 occurs when the graphic resources to be compared are index buffers. The original copy 112 may include a graphics resource index buffer 804 for comparison to a graphics resource index buffer 806 of the shadow copy 116.

At 802, the array of the index buffers 804, 806 is identified. For example, the entire array, or a portion thereof, is selected and identified prior to a comparison of the arrays. A sampling algorithm may select a portion of the information from each dimension such that the selected portion has a good distribution and randomness. For example, selecting only even or odd data may generate an inaccurate comparison because some arrays may appear very similar when non-random samples are compared to one another.

At 808, the index buffers 804, 806 are compared to determine whether the shadow copy 116 should have the requested resource updated from the original copy 112. In some embodiments, the comparison may include comparing each element, or a portion of the elements in the arrays 804, 806 to determine if they are the same.

In FIGS. 5-8, specific resource comparisons are described which may determine whether or not a shadow copy should be updated with a graphics resource from the original copy. However, other comparisons may be performed, such as comparing properties associated with the graphics resources or other metrics which may provide a useful indicator of whether the graphics resources are the same. In addition, while the content based system is described with respect to some illustrative sampling policies and hash techniques, the content based scheme is not limited to these illustrative policies, but may include other policies that enable updating the shadow copy 116 with a resource from the original copy 112 without replacing the entire shadow copy during each update.

### Illustrative Computing Device

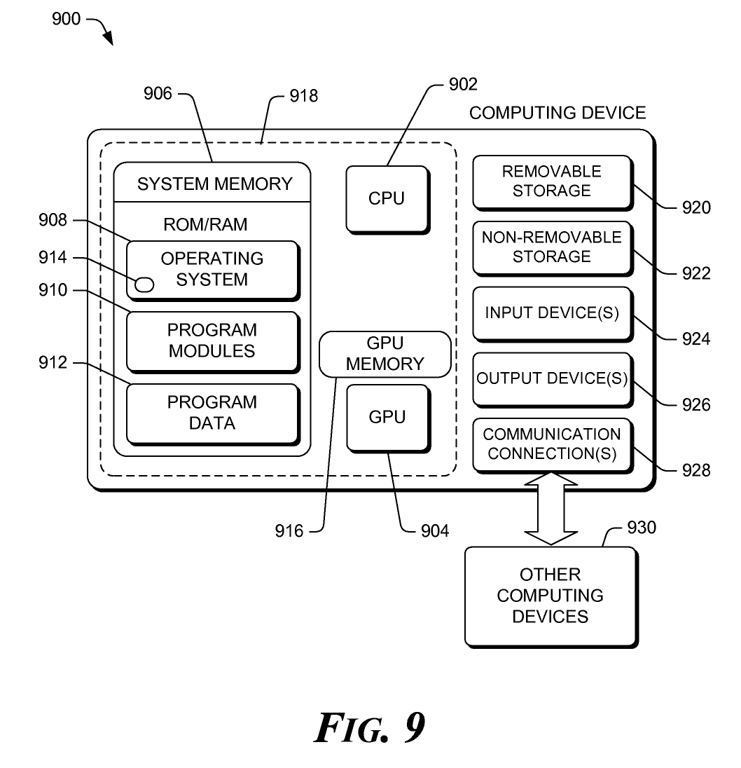

FIG. 9 shows an illustrative computing system that may be used to implement the content based cache for graphic resource management as shown in the environment of FIG. 1. It will readily be appreciated that the various embodiments of the sentiment classification techniques and mechanisms may be implemented in other computing devices, systems, and environments. The computing device 900 shown in FIG. 9 is only one example of a computing device and is not intended to suggest any limitation as to the scope of use or functionality of the computer and network architectures. The computing device 900 is not intended to be interpreted as having any dependency or requirement relating to any one or combination of components illustrated in the example computing device.

In a very basic configuration, the computing device 900 typically includes at least one CPU 902 and a second processing unit 904, such as a GPU. The computing device includes system memory 906 accessible to the CPU 902. Depending on the exact configuration and type of computing device, the system memory 906 may be volatile (such as RAM), non-volatile (such as ROM, flash memory, etc.) or some combination of the two. The system memory 906 typically includes an operating system 908, one or more program modules 910, and may include program data 912. The operating system 908 includes a component-based framework 914 that supports components (including properties and events), objects, inheritance, polymorphism, reflection, and provides an object-oriented component-based application programming interface (API). GPU memory 916 is available for access by the second processing unit (GPU) 904, such as to store the shadow copy 116 of graphics resources. The computing device 900 is of a very basic configuration demarcated by a dashed line 918. Again, a terminal may have fewer components but will interact with a computing device that may have such a basic configuration.

The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by removable storage 920 and non-removable storage 922. Computer storage media may include volatile and nonvolatile, removable and non-removable media implemented in any method or technology for storage of information, such as computer readable instructions, data structures, program modules, or other data. The system memory 906, the removable storage 920, and the non-removable storage 922 are all examples of computer storage media. The computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 900. Any such computer storage media may be part of the computing device 900. The computing device 900 may also have input device(s) 924 such as keyboard, mouse, pen, voice input device, touch input device, etc. Output device(s) 926 such as a display, speakers, printer, etc. may also be included. These devices are well known in the art and are not discussed at length here.

The computing device 900 may also contain communication connections 928 that allow the device to communicate with other computing devices 930, such as over a network. These networks may include wired networks as well as wireless networks. The communication connections 928 are one example of communication media. The communication media may typically be embodied by computer readable instructions, data structures, program modules, etc.

It is appreciated that the illustrated computing device 900 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like. For example, some or all of the components of the computing device 900 may be implemented in a cloud computing environment, such that resources and/or services are made available via a computer network for selective use by client devices.

### Conclusion

The above-described techniques pertain to content based cache for graphics resource management. Although the techniques have been described in language specific to structural features and/or methodological acts, it is to be understood that the appended claims are not necessarily limited to the specific features or acts described. Rather, the specific features and acts are disclosed as exemplary forms of implementing such techniques.

What is claimed is:

1. A method of managing graphic resources, the method comprising:
generating a hash key from an original copy of a resource that corresponds to a requested resource maintained in a shadow copy, where the shadow copy is updated from the original copy;
searching a hash table containing a hash for each loaded resource in the shadow copy; and
loading the corresponding resource from the original copy to the shadow copy when the hash key is not found in the hash table.

2. The method of claim 1, wherein generating a hash key is performed in response to a resource request by a graphics processing unit (GPU).

3. The method of claim 1, further comprising:
comparing at least a portion of the requested resource in the shadow copy to the corresponding resource in the original copy when the hash key is found in the hash table; and
loading the corresponding resource from the original copy to the shadow copy when the at least a portion of the requested resource in the shadow copy does not match the corresponding resource in the original copy.

4. The method of claim 3, wherein the comparing at least a portion of the requested resource includes comparing a portion of a texture by at least one of:
selecting a resolution of a mipmap texture for comparison between the requested resource in the shadow and the corresponding resource in the original copy; or
selecting a subsection of texels of a non-mipmap texture for comparison between the requested resource in the shadow and the corresponding resource in the original copy.

5. The method of claim 3, wherein the comparing at least a portion of the requested resource includes comparing a portion of a vertex buffer.

6. The method of claim 3, wherein the comparing at least a portion of the requested resource includes comparing a portion of an index buffer.

7. The method of claim 1, wherein the graphics resources include at least one of a texture, a vertex buffer, or an index buffer.

8. The method of claim 1, further comprising releasing a resource from the shadow copy when the corresponding resource is to be loaded to the shadow copy and the shadow copy does not have available memory to receive the corresponding copy.

9. One or more computer-readable media storing computer-executable instructions that, when executed on one or more processors, performs acts comprising:
populating a shadow copy of graphical resources from an original copy, the shadow copy configured for access by a graphics processing unit (GPU) and the original copy maintained by a central processing unit (CPU); and
updating a requested resource in the shadow copy from the original copy when the requested resource is not current.

10. The one or more computer-readable media as recited in claim 9, wherein the updating a requested resource includes:
creating a hash key from the original copy of an original resource that corresponds to the requested resource;
searching a hash table containing a hash for each loaded resource in the shadow copy; and
determining the status of the requested resource is not current when the hash key is not found in the hash table.

11. The one or more computer-readable media as recited in claim 10, further comprising:
comparing a portion of the requested resource in the shadow copy to the corresponding resource in the original copy when the hash key is found in the hash table; and
determining the status of the requested resource is not current when the portion of the requested resource in the shadow copy does not match the corresponding resource in the original copy.

12. The one or more computer-readable media as recited in claim 9, wherein the shadow copy is stored in cache dedicated to the GPU.

13. The one or more computer-readable media as recited in claim 9, wherein at least one resource of the shadow copy is not updated when the requested resource is updated.

14. A system for managing graphic resources, the system comprising:
a first processing unit to:
request a resource from a shadow copy containing graphics resources, and
process the requested resource when the resource is current;
a second processing unit to:
maintain an original copy of graphics resources,
determine a status of the requested resource in the shadow copy as one of current or not current, and
update the requested resource in a shadow copy by copying the selected resources from the original copy when the requested resource is not current; and
a bus to enable communication between the CPU and the GPU.

15. The system as recited in claim 14, wherein the first processing unit is a graphics processing unit (GPU) and the second processing unit is a central processing unit (CPU).

16. The system as recited in claim 14, wherein the determine the status of the requested resource further includes:
creating a hash key from the original copy of the corresponding resource;
searching a hash table containing a hash for each loaded resource in the shadow copy; and
determining the status of the requested resource is not current when the hash key is not found in the hash table.

17. The system as recited in claim 16, further comprising:
comparing a portion of the requested resource in the shadow copy to the corresponding resource in the original copy when the hash key is found in the hash table; and
determining the status of the requested resource is current when the portion of the requested resource in the shadow copy matches the corresponding resource in the original copy.

18. The system as recited in claim 14, wherein the graphics resources include at least one of a texture, a vertex buffer, or an index buffer.

19. The system as recited in claim 14, wherein the shadow copy is stored in cache of the first processing unit, and wherein the first processing unit is a graphics processing unit (GPU).

20. The system as recited in claim 14, wherein the first processing unit is configured to add a new hash to the hash table when the requested resource is updated in the shadow copy.
